(19) United States
(12) Patent Application Publication
(10) Pub. No.: US 2019/0132765 A1
(43) Pub. Date: May 2, 2019

(54) FLOW CONTROLLING A NETWORK STACK

(71) Applicant: QUALCOMM Incorporated, San Diego, CA (US)

(72) Inventors: James Cho, Mountain View, CA (US); Debashis Dutt, San Jose, CA (US)

(21) Appl. No.: 15/798,820

(22) Filed: Oct. 31, 2017

(51) Int. Cl. H04W 28/02; H04L 12/851; H04W 28/16

(52) U.S. Cl. CPC H04W 28/0268; H04L 47/24; H04W 28/0215; H04W 28/06; H04W 28/0289; H04W 28/0273; H04W 28/16

(57) ABSTRACT

This disclosure provides systems, devices, apparatus and methods, including computer programs encoded on storage media, for flow controlling a network stack. As one example, a method includes receiving, at a driver of a wireless device, an indicator associated with a transmission, determining an information flow status associated with the wireless device based at least in part on the received indicator, sending, to a network stack of the wireless device, a flow control message, the flow control message being based at least in part on the information flow status, and adjusting a transmission flow of one or more packets associated with the wireless device based at least in part on the flow control message. In some cases, the indicator includes an indication of congestion associated with a Quality of Service (QoS) level of the transmission.

### TECHNICAL FIELD

This disclosure relates generally to wireless communications, and more specifically, to flow controlling a network stack.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the 802.11 family of standards is a Basic Service Set (BSS), which is managed by an AP. Each BSS is identified by a service set identifier (SSID) that is advertised by the AP. An AP periodically broadcasts beacon frames to enable any STAs within wireless range of the AP to establish, or maintain, or both a communication link with the WLAN.

Wireless communications systems are widely deployed to provide various types of communication content such as voice, video, packet data, messaging, broadcast, and so on. These systems may be multiple-access systems capable of supporting communication with multiple users by sharing the available system resources (for example, time, frequency, and space). The AP may be coupled to a network, such as the Internet, and may enable a STA to communicate via the network including communicating with other devices coupled to the AP.

Some examples of wireless communications systems may include a network stack and a driver that may be included in various wireless devices, such as APs and STAs. In some cases, if the driver needs to flow control the network stack, all packets are stopped or delayed irrespective of priority. As a result, high priority packets as well as low priority packets are dropped or delayed in some circumstance. This results in poor latency for the high priority packet and leads to poor user experience and less efficient operations. There exists a need for efficient and effective flow control methods.

### SUMMARY

The described techniques relate to improved methods, systems, devices, or apparatuses that support flow controlling a network stack. Some examples of wireless communications systems may include wireless devices such as access points (APs) and stations (STAs), one or more of which may support flow controlling in a network stack. The AP and STA may each include a driver and a network stack. In some cases, a driver of a wireless device may receive an indicator from a device portion of the wireless device. In some cases, the indicator may be associated with a transmission of a data packet. In some cases, the indicator may include a Quality of Service (QoS) level. In another example, the indicator may also include a destination address. In some examples, the indicator may additionally or alternatively indicate a Transmission Control Protocol (TCP) or User Datagram Protocol (UDP) flow.

In some examples, the driver may determine an information flow status based on the received indicator. In one example, the driver may determine an information flow status based on a QoS level, a destination address, or both. In another example, the driver may determine an information flow status based on a TCP/UDP flow identifier. In some examples, the driver may send a flow control message based on the information flow status to a network stack of the wireless device. In some examples, the network stack, upon receiving the information flow message, may adjust a transmission flow of one or more packets based on the flow control message.

The systems, methods and devices of this disclosure each have several innovative aspects, no single one of which is solely responsible for the desirable attributes disclosed herein.

One innovative aspect of the subject matter described in this disclosure can be implemented in a method for wireless communication at a wireless device. In some implementations, the method includes receiving, at a driver of the wireless device, an indicator associated with a transmission, determining an information flow status associated with the wireless device based at least in part on the received indicator, sending, to a network stack of the wireless device, a flow control message, the flow control message being based at least in part on the information flow status, and adjusting a transmission flow of one or more packets associated with the wireless device based at least in part on the flow control message.

Another innovative aspect of the subject matter described in this disclosure can be implemented in an apparatus for wireless communication at a wireless device. The apparatus includes means for receiving, at a driver of the wireless device, an indicator associated with a transmission, means for determining an information flow status associated with the wireless device based at least in part on the received indicator, means for sending, to a network stack of the wireless device, a flow control message, the flow control message being based at least in part on the information flow status, and means for adjusting a transmission flow of one or more packets associated with the wireless device based at least in part on the flow control message.

Another innovative aspect of the subject matter described in this disclosure can be implemented in another apparatus for wireless communication. The apparatus includes a processor, memory in electronic communication with the processor, and instructions stored in the memory. The instructions may be operable to cause the processor to receive, at a driver of the apparatus, an indicator associated with a transmission, determine an information flow status associated with the apparatus based at least in part on the received indicator, send, to a network stack of the apparatus, a flow control message, the flow control message being based at least in part on the information flow status, and adjust a transmission flow of one or more packets associated with the apparatus based at least in part on the flow control message.

Another innovative aspect of the subject matter described in this disclosure can be implemented in a non-transitory computer-readable medium for wireless communication at a wireless device. The non-transitory computer-readable medium includes instructions operable to cause a processor to receive, at a driver of the wireless device, an indicator associated with a transmission, determine an information flow status associated with the wireless device based at least in part on the received indicator, send, to a network stack of the wireless device, a flow control message, the flow control message being based at least in part on the information flow status, and adjust a transmission flow of one or more packets associated with the wireless device based at least in part on the flow control message.

In some implementations of the method, apparatus, and non-transitory computer-readable medium described above, the indicator includes an indication of congestion associated with a QoS level of the transmission.

Some examples of the method, apparatus, and non-transitory computer-readable medium described above may further include processes, features, means, or instructions for mapping the QoS level to a socket based at least in part on the indicator associated with the transmission. In some cases, adjusting the transmission flow of one or more packets includes refraining from transmitting one or more packets from the socket.

Some examples of the method, apparatus, and non-transitory computer-readable medium described above may further include processes, features, means, or instructions for identifying at least one internal queue associated with the QoS level. In some cases, adjusting the transmission flow of one or more packets includes refraining from transmitting one or more packets associated with the at least one internal queue.

Some examples of the method, apparatus, and non-transitory computer-readable medium described above may further include processes, features, means, or instructions for creating at least one internal queue associated with the QoS level. In some cases, adjusting the transmission flow of one or more packets includes refraining from transmitting one or more packets associated with the at least one internal queue. In some implementations of the method, apparatus, and non-transitory computer-readable medium described above, the indicator further includes an indication of a destination address associated with the transmission.

Some examples of the method, apparatus, and non-transitory computer-readable medium described above may further include processes, features, means, or instructions for mapping the QoS level and the destination address to a socket based at least in part on the indicator associated with the transmission. In some cases, adjusting the transmission flow of one or more packets includes refraining from transmitting one or more packets from the socket.

Some examples of the method, apparatus, and non-transitory computer-readable medium described above may further include processes, features, means, or instructions for identifying at least one internal queue associated with the QoS level and the destination address. In some cases, adjusting the transmission flow of one or more packets includes refraining from transmitting one or more packets associated with the at least one internal queue.

Some examples of the method, apparatus, and non-transitory computer-readable medium described above may further include processes, features, means, or instructions for creating at least one internal queue associated with the QoS level and the destination address. In some cases, adjusting the transmission flow of one or more packets includes refraining from transmitting one or more packets associated with the at least one internal queue.

In some implementations of the method, apparatus, and non-transitory computer-readable medium described above, the indicator is associated with a TCP/UDP flow. In some implementations of the method, apparatus, and non-transitory computer-readable medium described above, the indicator further includes one or more of an Internet Protocol (IP) destination address, an IP source address, an IP protocol, a TCP/UDP source port, or a TCP/UDP destination port.

Some examples of the method, apparatus, and non-transitory computer-readable medium described above may further include processes, features, means, or instructions for mapping the TCP/UDP flow to a socket based at least in part on the indicator associated with the transmission. In some cases, adjusting the transmission flow of one or more packets includes refraining from transmitting one or more packets from the socket.

Some examples of the method, apparatus, and non-transitory computer-readable medium described above may further include processes, features, means, or instructions for sending, using an application program interface (API) of the network stack, a flow identifier message identifying the TCP/UDP flow. Some examples of the method, apparatus, and non-transitory computer-readable medium described above may further include processes, features, means, or instructions for sending, using an API of the network stack, a flow statistics message identifying one or more statistics associated with the TCP/UDP flow.

In some implementations of the method, apparatus, and non-transitory computer-readable medium described above, the one or more statistics associated with the TCP/UDP flow further includes one or more of a number of packets associated with the TCP/UDP flow, a number of bytes associated with the TCP/UDP flow, QoS level associated with the TCP/UDP flow.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 illustrates an example of a wireless communications system that supports flow controlling a network stack in accordance with various aspects of the present disclosure.

FIG. 2 illustrates a first example of a system architecture that supports flow control in accordance with various aspects of the present disclosure.

FIG. 3 illustrates a second example of a system architecture that supports flow control in accordance with various aspects of the present disclosure.

FIG. 4 illustrates an example of a process flow that supports flow controlling a network stack in accordance with various aspects of the present disclosure.

FIG. 5 illustrates a block diagram of an access point (AP) that supports flow controlling a network stack in accordance with various aspects of the present disclosure.

FIG. 6 illustrates a block diagram of a station (STA) that supports flow controlling a network stack in accordance with various aspects of the present disclosure.

FIGS. 7 through 9 show block diagrams of a wireless device that supports flow controlling a network stack in accordance with various aspects of the present disclosure.

FIG. 10 through 12 illustrate methods for flow controlling a network stack in accordance with various aspects of the present disclosure.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to any of the IEEE 802.11 standards, or the Bluetooth® standards. The described implementations also can be implemented in any device, system or network that is capable of transmitting and receiving RF signals according to any of the following technologies or techniques: code division multiple access (CDMA), frequency division multiple access (FDMA), orthogonal frequency division multiple access (OFDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Various implementations relate generally to wireless communications. Some implementations more specifically relate to flow controlling a network stack associated with a wireless device. Particular implementations of the subject matter described in this disclosure can be implemented to realize one or more of the following potential advantages. In some implementations, the described techniques can be used to reduce high priority packet latency, memory footprint, and Central Processing Unit (CPU) utilization.

An access point (AP) or station (STA) may support flow controlling a network stack. The AP, the STA, or both may each include a driver and a network stack. In some cases, a driver may receive an indicator associated with a transmission of a data packet. More specifically, the device may receive an indicator associated with congestion related to transmission of the data packet. For example, the driver at a wireless device may receive an indication of congestion at a portion of the wireless device. In some cases, the indicator may include an indication of congestion associated with a Quality of Service (QoS) level. In some other examples, the indicator may include an indication of congestion associated with a QoS level and a destination address, among other aspects. In some cases, the destination of an AP may be a STA, and vice versa. In some examples, the indicator may include an indication of congestion associated with Transmission Control Protocol (TCP) or User Datagram Protocol (UDP) flow. The TCP/UDP flow may be identified using an Internet Protocol (IP) destination address, an IP source address, an IP protocol, a TCP/UDP source port, a TCP/UDP destination port, or a combination thereof.

In some implementations, the driver determines an information flow status based on a received indicator. For example, the driver may determine the information flow status based on a QoS level, a destination address, or both. In another example, the driver may determine an information flow status based on the TCP/UDP flow identifier. In some examples, the driver may send a flow control message to a network stack based on the information flow status. In some examples, the network stack, upon receiving the flow control message, may adjust, or otherwise initiate an adjustment of, a transmission flow of one or more packets based on the flow control message. Additional operations associated with these aspects and other related aspects are described herein.

Aspects of the disclosure are initially described in the context of a wireless communications system. Aspects of the disclosure are further illustrated by and described with reference to apparatus diagrams, system diagrams, and flowcharts that relate to flow controlling a network stack.

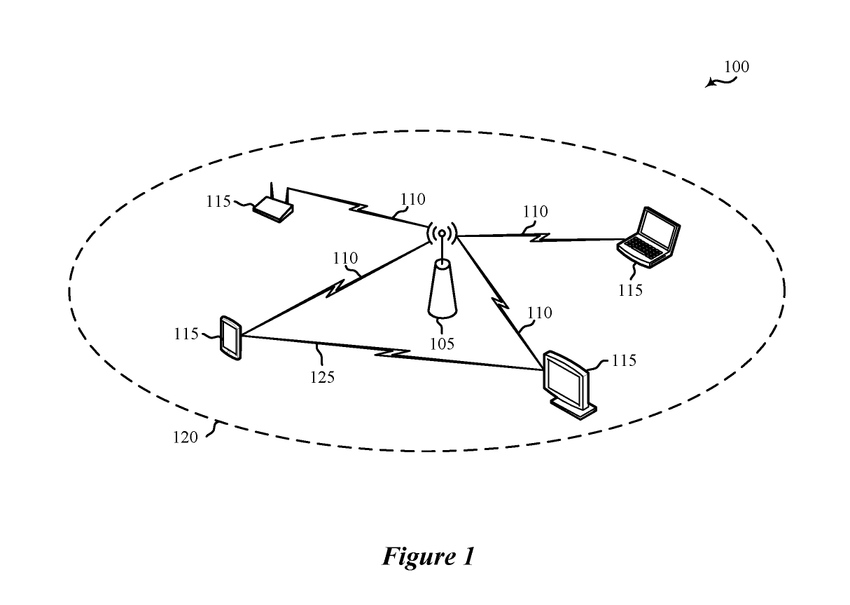

FIG. 1 illustrates an example of a wireless communications system 100 that supports flow controlling a network stack in accordance with various aspects of the present disclosure. According to some aspects, the wireless communications system 100 can be an example of a wireless local area network (WLAN) (and will hereinafter be referred to as WLAN 100). For example, the WLAN 100 can be a network implementing at least one of the IEEE 802.11 family of standards. The WLAN 100 may include numerous wireless devices such as an AP 105 and multiple associated STAs 115. Each of the STAs 115 also may be referred to as a mobile station (MS), a mobile device, a mobile handset, a wireless handset, an access terminal (AT), a user equipment (UE), a subscriber station (SS), or a subscriber unit, among other possibilities. The STAs 115 may represent various devices such as mobile phones, personal digital assistant (PDAs), other handheld devices, netbooks, notebook computers, tablet computers, laptops, display devices (for example, TVs, computer monitors, navigation systems, among others), printers, key fobs (for example, for passive keyless entry and start (PKES) systems), among other possibilities.

Each of the STAs 115 may associate and communicate with the AP 105 via a communication link 110. The various STAs 115 in the network are able to communicate with one another through the AP 105. A single AP 105 and an associated set of STAs 115 may be referred to as a basic service set (BSS). FIG. 1 additionally shows an example coverage area 120 of the AP 105, which may represent a basic service area (BSA) of the WLAN 100. While only one AP 105 is shown, the WLAN network 100 can include multiple APs 105. An extended service set (ESS) may include a set of connected BSSs. An extended network station associated with the WLAN 100 may be connected to a wired or wireless distribution system that may allow multiple APs 105 to be connected in such an ESS. As such, a STA 115 can be covered by more than one AP 105 and can associate with different APs 105 at different times for different transmissions.

STAs 115 may function and communicate (via the respective communication links 110) according to the IEEE 802.11 family of standards and amendments including, but not limited to, 802.11a, 802.11b, 802.11g, 802.11n, 802.11ac, 802.11ad, 802.11ah, 802.11ay, 802.11ax, 802.11az, and 802.11ba. These standards define the WLAN radio and baseband protocols for the physical (PHY) and medium access control (MAC) layers. The wireless devices in the WLAN 100 may communicate over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. The unlicensed spectrum may also include other frequency bands, such as the emerging 6 GHz band. The wireless devices in the WLAN 100 also can be configured to communicate over other frequency bands such as shared licensed frequency bands, where multiple operators may have a license to operate in the same or overlapping frequency band or bands.

In some cases, STAs 115 may form networks without APs 105 or other equipment other than the STAs 115 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 115 may be capable of communicating with each other through the AP 105 using communication links 110, STAs 115 also can communicate directly with each other via direct wireless communication links 125. Additionally, two STAs 115 may communicate via a direct communication link 125 regardless of whether both STAs 115 are associated with and served by the same AP 105. In such an ad hoc system, one or more of the STAs 115 may assume the role filled by the AP 105 in a BSS. Such a STA 115 may be referred to as a group owner (GO) and may coordinate transmissions within the ad hoc network. Examples of direct wireless communication links 125 include Wi-Fi Direct connections, connections established by using a Wi-Fi Tunneled Direct Link Setup (TDLS) link, and other peer-to-peer (P2P) group connections.

Some types of STAs 115 may provide for automated communication. Automated wireless devices may include those implementing internet-of-things (IoT) communication, Machine-to-Machine (M2M) communication, or machine type communication (MTC). IoT, M2M or MTC may refer to data communication technologies that allow devices to communicate without human intervention. For example, IoT, M2M or MTC may refer to communications from STAs 115 that integrate sensors or meters to measure or capture information and relay that information to a central server or application program that can make use of the information or present the information to humans interacting with the program or application.

Some of STAs 115 may be MTC devices, such as MTC devices designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. An MTC device may operate using half-duplex (one-way) communications at a reduced peak rate. MTC devices may also be configured to enter a power saving “deep sleep” mode when not engaging in active communications.

WLAN 100 may support beamformed transmissions. As an example, an AP 105 may use multiple antennas or antenna arrays to conduct beamforming operations for directional communications with a STA 115. Beamforming (which may also be referred to as spatial filtering or directional transmission) is a signal processing technique that may be used at a transmitter (such as an AP 105) to shape, or steer, or both an overall antenna beam in the direction of a target receiver (such as a STA 115). Beamforming may be achieved by combining elements in an antenna array in such a way that transmitted signals at particular angles experience constructive interference while others experience destructive interference. In some cases, the ways in which the elements of the antenna array are combined at the transmitter may depend on channel state information (CSI) associated with the channels over which the AP 105 may communicate with the STA 115. That is, based on this CSI, the AP 105 may appropriately weight the transmissions from each antenna (or antenna port) such that the desired beamforming effects are achieved. In some cases, these weights may be determined before beamforming can be employed. For example, the transmitter (for example, the AP 105) may transmit one or more sounding packets to the receiver in order to determine CSI.

WLAN 100 may further support multiple-input, multiple-output (MIMO) wireless systems. Such systems may use a transmission scheme between a transmitter (such as an AP 105) and a receiver (such as a STA 115), where both transmitter and receiver are equipped with multiple antennas. For example, an AP 105 may have an antenna array with a number of rows and columns of antenna ports that the AP 105 may use for beamforming in its communication with a STA 115. Signals may be transmitted multiple times in different directions (such as each transmission may be beamformed differently). The receiver (such as STA 115) may try multiple beams (such as antenna subarrays) while receiving the signals.

WLAN PDUs may be transmitted over a radio frequency spectrum band, which in some examples may include multiple sub-bands or frequency channels. In some cases, the radio frequency spectrum band may have a bandwidth of 160 MHz, and each of the sub-bands or channels may have a bandwidth of 20 MHz. Transmissions to and from STAs 115 and APs 105 typically include control information within a header that is transmitted prior to data transmissions. The information provided in a header is used by a receiving device to decode the subsequent data. A legacy WLAN preamble may include legacy short training field (STF) (L-STF) information, legacy LTF (L-LTF) information, and legacy signaling (L-SIG) information. The legacy preamble may be used for packet detection, automatic gain control and channel estimation, among other uses. The legacy preamble may also be used to maintain compatibility with legacy devices.

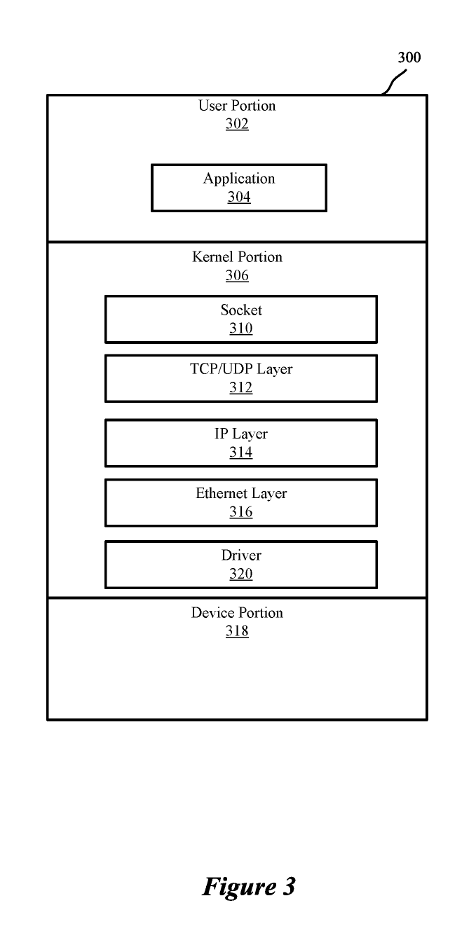

The AP 105 or the STA 115 may support flow controlling a network stack. The AP 105, the STA 115, or both may each include a device portion, a kernel portion, and a user portion, as described with reference to FIG. 3. In some implementations, the device portion may include a hardware layer. In some implementations, the user portion may include one or more applications. In some cases, the kernel portion may include a driver, and a network stack. In some examples, the driver may receive an indicator associated with a data packet from the device portion. For example, the driver at the AP 105 may receive an indication of congestion at a device portion of the AP 105. Similarly, the driver at the STA 115 may receive an indication of congestion at a device portion of the STA 115. In some examples, the driver may receive an indicator related to congestion associated with transmission of data packets. In some cases, the indicator may include an indication of congestion associated with a QoS level or a QoS level and a destination address. In some cases, the destination of an AP 105 may be a second AP 105 (not shown), STA 115, or both. In some cases, the destination of an STA 115 may be a second STA 115, AP 105, or both. In some examples, the indicator may include an indication of congestion associated with TCP/UDP flow.

In some examples, the driver may then determine an information flow status based on the received indicator. In one example, the information flow status may be based on a QoS level. For example, the information flow status at a wireless device (such as AP 105 or STA 115) may be based on the QoS level specified in the indicator received from the device portion of the wireless device. In some examples, the driver may determine an information flow status based on a QoS level and a destination address. In another example, the driver may determine an information flow status based on the TCP/UDP flow identifier. In some examples, the driver may generate and send a flow control message to a network stack based on the information flow status. In some examples, the network stack, upon receiving the flow control message, may adjust, or otherwise initiate an adjustment of, a transmission flow of one or more packets. In some examples, the transmission flow may be adjusted based on the flow control message.

In some cases, a driver of the AP 105 or the STA 115 may receive an indicator associated with a transmit queue. For example, the driver at the AP 105 may receive an indication of congestion at a device portion of the AP 105. Similarly, the driver at the STA 115 may receive an indication of congestion at a device portion of the STA 115. For example, the indicator may include an indication of congestion associated with a QoS. The indicator may, in some examples, identify a QoS level.

In some other examples, the indicator may include an indication of congestion associated with both a QoS and a destination. For example, the indicator may indicate an occurrence of a congestion at a transmit queue for data packets having a QoS level and being directed to a destination. In such implementations or instances, the indicator may identify both the QoS and the destination. In some cases, the destination for the AP 105 may be the STA 115. Likewise, the destination for the STA 115 may be the AP 105. Further, in some examples, the indicator may include an indication of congestion associated with TCP/UDP flow at the device portion.

In some implementations, a QoS may be or include a description or measurement of an overall performance of a service. In some implementations, a device portion of the AP 105 or the STA 115 may use error rates, bit rate, throughput, transmission delay, availability, and jitter, to quantitatively determine a QoS level. In some implementations, a QoS level may refer to traffic prioritization, resource reservation and control mechanisms. More specifically, a QoS may be or include an ability to provide different priority to different applications or data flows to guarantee a predefined level of performance to a data flow.

In some examples, upon receiving the indicator, the driver may determine an information flow status based on the received indicator. For example, the driver at the AP 105 may determine an information flow status associated with the AP 105. Similarly, the driver at the STA 115 may determine an information flow status associated with the STA 115. In some examples, the driver may send to a network stack of the wireless device, a flow control message based on the information flow status. For example, the driver in the AP 105 may generate a flow control message and may send the flow control message to the network stack at the AP 105. Similarly, the driver in the STA 115 may generate a flow control message and may send the flow control message to the network stack at the STA 115.

In some examples, the network stack, upon receiving the information flow message, may adjust a transmission flow of one or more packets based on the flow control message. As previously discussed, upon receiving a flow control message from the driver at the AP 105, the network stack of the AP 105 may adjust a transmission of one or more packets within the network stack based on the received flow control message. Similarly, upon receiving a flow control message from the driver at the STA 115, the network stack of the STA 115 may adjust a transmission of one or more packets within the network stack based on the received flow control message.

In some examples, the network stack may determine a QoS associated with the flow control message. Upon determining the QoS, the network stack may refrain from transmitting packets associated with the QoS level. Similarly, the network stack may determine a QoS level and a destination address associated with the flow control message. Upon determining the QoS level and the destination address, the network stack may refrain from transmitting packets associated with both the QoS level and the destination address. Additionally or alternatively, the network stack may determine a flow identifier associated with a TCP/UDP flow identified in the flow control message. The flow identifier may be a 5-tuple identifier including one or more of an IP destination address, an IP source address, an IP protocol, a TCP/UDP source port, or a TCP/UDP destination port. Upon determining the flow identifier, the network stack may refrain from transmitting packets associated with the TCP/UDP flow identified in the flow control message.

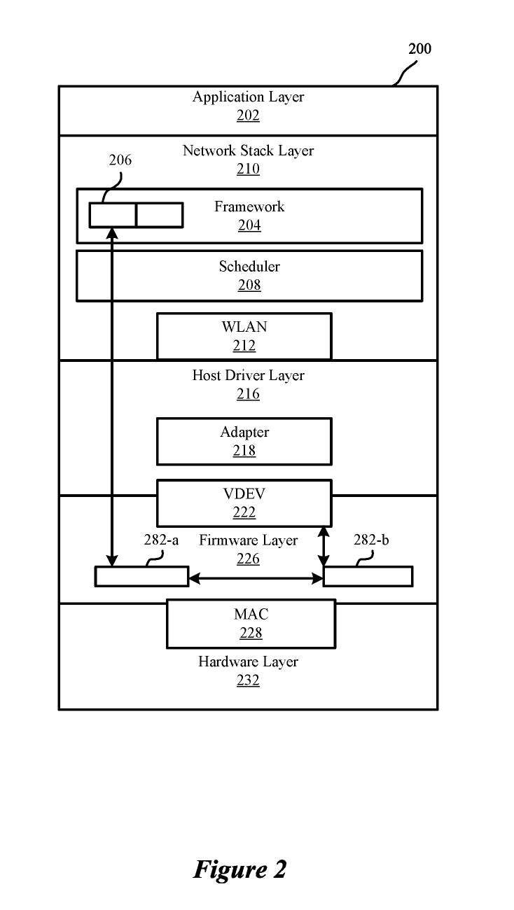

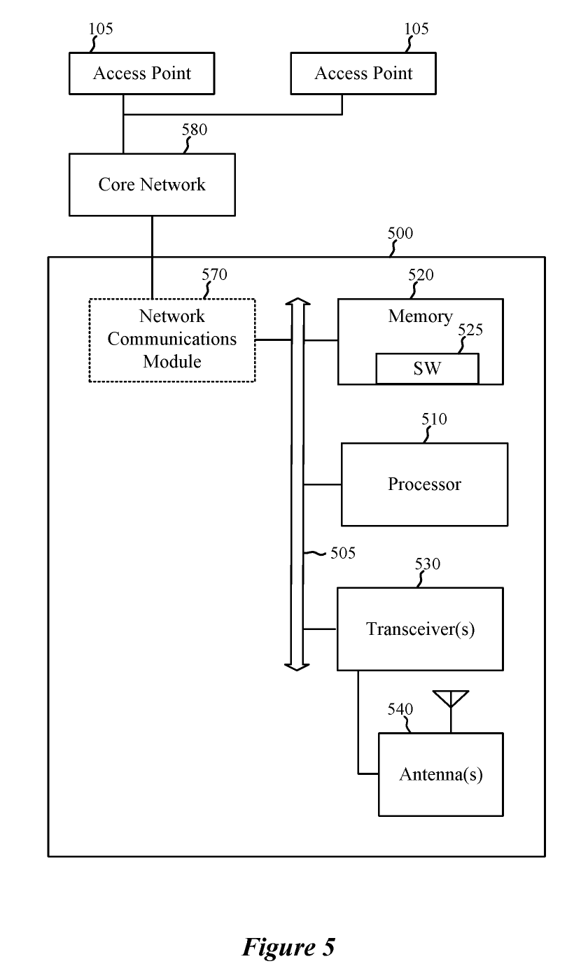

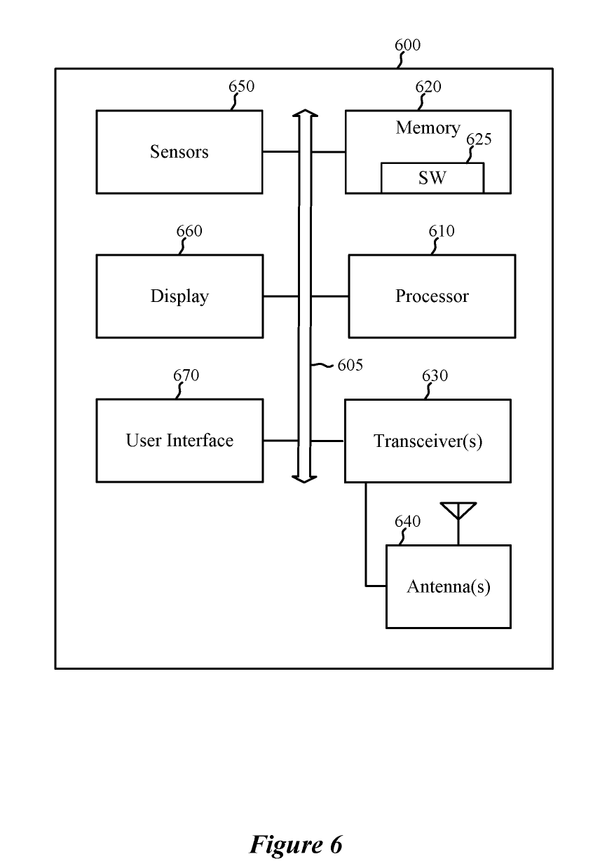

FIG. 2 illustrates an example of a system architecture 200 that supports flow control in accordance with various aspects of the present disclosure. In some examples, the system architecture 200 may be included in a STA 115 or an AP 105. A STA 115 may be an example of, or include the components of, a wireless device such as a wireless device 600, a wireless device 705, or a wireless device 805, described below with reference to FIGS. 6, 7 and 8, respectively. An AP 105 may be an example of, or include the components of, a wireless device such as a wireless device 500, a wireless device 705, or a wireless device 805, described below with reference to FIGS. 5, 7 and 8, respectively.

In some examples, a STA 115, an AP 105, or both (as described with reference to FIG. 1 and other figures) may include an application layer 202, a network stack layer 210, a host driver layer 216, a firmware layer 226, and a hardware layer 232. The application layer 202 may support application and end-user processes. In some cases, application layer 202 identifies communication partners (for example, an AP 105 and a STA 115), user authentication, privacy, and any constraints on data syntax. The application layer 202 may additionally provide application services for file transfers, e-mail, and other network software services.

In some examples, network stack layer 210 may include a framework 204, data flows 206, and a scheduler 208. The framework 204 may provide higher-level services to applications running on the respective wireless device. In some cases, framework 204 may provide controls of an application lifecycle and activity stack. Framework 204 may additionally allow applications to publish and share data with other applications. In some examples, framework 204 may provide alerts and notifications. In some cases, data flows 206 may be associated with an application running on the respective wireless device. Data flows 206 may be associated with a stream of data packets that correspond to a transmission chain. In some cases, data flows 206 may include a number of elements. For example, data flows 206 may include five elements (such as a 5-tuple). In some examples, the 5-tuple data flow may include an IP destination address, an IP source address, an IP protocol, a TCP/UDP source port, and a TCP/UDP destination port.

The network stack layer 210 may relate to a WLAN 212. In some cases, the network stack layer 210 may provide transmission of data flows from a STA 115 to an AP 105, or vice versa, using WLAN 212. In some examples, the host driver layer 216 may send a flow control message to the network stack layer 210. The network stack layer 210 may adjust a transmission flow of one or more packets based on the flow control message.

In some examples, a scheduler 208 may be synchronized with a scheduler of an AP (such as AP 105). In some examples, the scheduler 208 may be synchronized with a scheduler of a STA (such as STA 115). In some cases, a STA 115, an AP 105, or both may identify data traffic associated with the data flows. A data flow may include a number of elements, such as five sequential elements. The elements of a data flow may be associated with a same application. In some cases, scheduler 208 may use a hash mapper table for mapping a data flow to a port. In some cases, a STA 115, an AP 105, or both may use a scheduler 208 to schedule data flows based on the identified data traffic. In some examples, the scheduler 208 may be used in conjunction with the network stack layer 210 to flow control data packets.

In an example in which the architecture 200 is implemented in a STA 115, the host driver layer 216 may provide one or more functionalities for an application layer 202 to communicate with one or more components of the STA 115. Similarly, in an example in which the architecture 200 is implemented in an AP 105, the host driver layer 216 may provide one or more functionalities for an application layer 202 to communicate with one or more components of the AP 105. The host driver layer 216 may include an adapter 218. In one example, an adapter 218 may provide communication to one or more other components of the respective wireless device (STA 115 or AP 105).

In some examples the firmware layer 226 may receive data flows from MAC 228 associated with the hardware layer 232. In an example in which the architecture 200 is implemented in a STA 115, the MAC 228 may transmit data flows associated with a source address (for example, STA 115) to a higher layer of the STA 115 or to an AP 105. In an example in which the architecture 200 is implemented in an AP 105, the MAC 228 may transmit data flows associated with a source address (for example, AP 105) to a higher layer of the AP 105 or to a STA 115. In another example in which the architecture 200 is implemented in a STA 115, the MAC 228 may transmit data flows associated with a source address to a higher layer of the STA 115 or to a second STA 115.

In some examples, data packets of a data flow may include at least one address field. In some cases, the address field may include at least one of a receiver address, a transmitter address, a destination address, a source address, or a combination thereof. In some cases, data flows 282-b may be associated with an address of the MAC 228. As a result, the data flows 282-b may be directed to a virtual device (VDEV) 222 associated with the MAC 228 based on the address associated with the data flows. In some examples, data flows 282-a may be forwarded to a radio communication link based on analyzing the data flows 282-a.

In some examples, the firmware layer 226 may send a message to the host driver layer 216 indicating that a packet is causing congestion. In some examples, congestion may be determined based on a QoS level associated with the packet, and the driver then starts flow control. In some cases, transmissions associated with one destination can cause congestion for transmissions to all destinations having the same QoS level. The flow control message is used to determine how the flow control is going to be performed at a device portion. In some examples, the host driver layer 216 generates an internal queue associated with that QoS level and then flow controls that queue. In some other examples, the host driver layer 216 may identify packets associated with that QoS level and block such packets from proceeding.

In some examples, flow control of data packets may be performed by the host driver layer 216, the firmware layer 226, the MAC 228, or any combination thereof. In some examples, the firmware layer 226 may determine that a congestion is caused by data packets associated with a QoS level. In some examples, the firmware layer 226 may determine that the congestion is caused by data packets associated with a QoS level and a destination address. In some other examples, the firmware layer 226 may determine that the congestion is caused by data packets associated with a TCP/UDP flow. The firmware layer 226 may send an indication of congestion to the host driver layer 216. The indication of congestion may, for example, include an indicator indicating a reason or source of congestion. Upon receiving the indicator, the host driver layer 216 may then determine an information flow status based on the received indicator. For example, the host driver layer 216 may generate a flow control message based on the received QoS level (in other words, the QoS level causing a congestion). In some examples, the host driver layer 216 may generate a flow control message based on the received QoS level and the destination. In some other examples, the host driver layer 216 may generate a flow control message based on the received TCP/UDP flow.

In some examples, the host driver layer 216 may then send the flow control message to the network stack layer 210. In one example, the network stack layer 210 may perform a mapping from each QoS level to each destination and each socket associated with the QoS level. In some examples, the network stack layer 210 may perform a mapping from each QoS level and destination to each socket for that combination of QoS and destination. In some other examples, upon receiving the flow control message, the network stack layer 210 may adjust a transmission flow of one or more packets associated with the flow control message.

FIG. 3 illustrates an example of a system architecture 300 that supports flow control in accordance with various aspects of the present disclosure. In some examples, system architecture 300 may be included in a STA 115 or an AP 105. A STA 115 may be an example of, or include the components of, a wireless device such as the wireless device 600, the wireless device 705, or the wireless device 805 described below with reference to FIGS. 6, 7 and 8, respectively. An AP 105 may be an example of, or include the components of, a wireless device such as the wireless device 500, the wireless device 705, or the wireless device 805 described below with reference to FIGS. 5, 7 and 8, respectively.

In the example of FIG. 3, a STA 115, an AP 105, or both may include a user portion 302, a kernel portion 306, and a device portion 318. FIG. 3 is described with reference to a TCP flow or a UDP flow. In some examples, the user portion 302 and the kernel portion 306 may be referred to as a “host” portion of the respective wireless device, and the device portion 318 may be referred to as a “target” portion of the respective wireless device. In some examples, the device portion 318 may include a Network Interface Card (NIC). The NIC may be configured to send and receive packets from a STA 115 to an AP 105, or vice versa.

In some examples, as part of packet transmission using TCP protocol, the application 304 generates data for transmission (for example, in the form of one or more data packets). In some examples, the data is related to application and end-user processes. In some cases, the application 304 may identify communication partners (such as an AP 105 and a STA 115) and QoS levels. In some implementations, the application 304 may perform user authentication and verify privacy settings.

In the kernel portion 306, a socket 310 may be associated with the application 304. In some cases, the socket 310 may be related to the application 304 using a file descriptor. In some examples, the socket 310 may have at least two buffers. One buffer may be a send socket buffer and another buffer may be a receive socket buffer. The send socket buffer may generate a queue for packet transmission. The receive buffer may generate another queue for packet reception. In some examples, the data from the user portion 302 (such as from application 304) is added to the end of the send socket buffer. After adding the packet to a send socket buffer, the wireless device may designate a protocol associated with the packet transmission. In one example of the system architecture of FIG. 3, the designated protocol is a TCP protocol. In another example, the designated protocol is a UDP protocol.

In the example of a TCP protocol, a TCP Control Block (TCB) structure may be connected to the socket 310. The TCB may include data related to a future TCP connection. In some examples, the TCB may include connection state data, a receive window, a congestion window, a sequence number, a resending timer, or a combination thereof. If the current TCP state allows for data transmission, a new TCP segment (in other words, a packet) is created. If data transmission is impossible due to flow control, the system call is ended and the wireless device is returned to a user mode in which control is passed to the application 304.

Flow control of data packets may be performed by a driver 320 of the kernel portion 306 in conjunction with the device portion 318. In some examples, the device portion 318 may receive a notification of congestion of data packets. For example, the device portion 318 may determine that a congestion is caused by data packets associated with a particular QoS level. The device portion 318 may then send a message to the driver 320 indicating that a packet is causing congestion. In some cases, the device portion 318 may send to the driver 320 an indicator associated with the QoS level. Upon receiving the indicator, the driver 320 may then determine an information flow status based on the received indicator. For example, the driver 320 may generate a flow control message based on the received QoS level (that is, the QoS level causing the congestion at the device portion 318).

In some examples, the driver 320 may then send the flow control message to other components of the kernel portion 306. In some implementations, the network stack may be included in the kernel portion 306. The flow control message may determine how the flow control of outgoing packets is going to be performed at the device portion 318. In one example, the kernel portion 306 (or network stack) may map the QoS level to a socket 310. The kernel portion 306 may then adjust a transmission flow of one or more packets based on the QoS level. In some examples, upon receiving the flow control message associated with the QoS level, the kernel portion 306 may perform a mapping from each QoS level to each destination and each socket associated with the QoS level. In some examples, upon receiving the flow control message associated with the QoS level, the kernel portion 306 may identify internal queues associated with the QoS level. The kernel portion 306 may then refrain from transmitting packets from the identified queues. In some further examples, upon receiving the flow control message associated with the QoS level, the kernel portion 306 may create at least one internal queue associated with the QoS level, and may then refrain from transmitting packets from the created internal queue.

In another example in which flow control is performed by the driver 320 in conjunction with device portion 318, the device portion 318 may determine that a congestion is caused by data packets associated with a QoS level and a destination address. For example, the destination address may be an address of an AP 105 or a STA 115. The device portion 318 may then send a message to the driver 320 including an indicator associated with the QoS level and the destination address. Upon receiving the indicator, the driver 320 may then determine an information flow status based on the received indicator. For example, the driver 320 may generate a flow control message based on the received QoS level and the received destination address (in other words, the combination of the QoS level and the destination address causing the congestion at the device portion 318).

In some examples, the driver 320 may send the flow control message to other components of the kernel portion 306. In some examples, the kernel portion 306 (or network stack) may map the QoS level and the destination address to a socket 310. In some examples, upon receiving the flow control message associated with a QoS level and a destination address, the kernel portion 306 may perform a mapping from each QoS level and destination address to each socket 310 associated with the combination of QoS level and destination address. In some cases, the kernel portion 306 may then adjust a transmission flow of one or more packets based on the QoS level and the destination address. In some examples, upon receiving the flow control message associated with the QoS level and the destination address, the kernel portion 306 may identify internal queues associated with the QoS level and the destination address. The kernel portion 306 may then refrain from transmitting one or more packets from the identified queues. In some examples, upon receiving the flow control message associated with the QoS level and the destination address, the kernel portion 306 may create at least one internal queue associated with the QoS level and the destination address, and may then refrain from transmitting packets from the created internal queue.

In another example in which flow control of data packets is performed by the driver 320 in conjunction with device portion 318, the device portion 318 may determine that a congestion is caused by data packets associated with a TCP or a UDP flow. The device portion 318 may then send a message to the driver 320 including an indicator associated with the TCP or UDP flow. For example, the indicator may include one or more of an IP destination address, an IP source address, an IP protocol, a TCP/UDP source port, or a TCP/UDP destination port. Upon receiving the indicator, the driver 320 may determine an information flow status based on the received indicator. For example, the driver 320 may generate a flow control message based on the received TCP/UDP flow.

In some examples, the driver 320 may send the flow control message to other components of the kernel portion 306. In some examples, upon receiving the flow control message associated with a TCP/UDP flow, the kernel portion 306 (or network stack) may block a socket 310 associated with the TCP/UDP flow. In other words, upon receiving the flow control message associated with the TCP/UDP flow, the kernel portion 306 may refrain from transmitting packets from a socket 310 associated with the TCP/UDP flow. In this example, the kernel portion 306 may allow other flows for the same QoS and same destination to continue.

The allowed packets may then be transmitted using TCP/UDP protocol. In case of the TCP protocol, the allowed packet may be sent to the IP layer 314. The IP layer 314 may add an IP header to the packet (TCP segment of the packet). In some examples, the IP layer 314 may perform IP routing. In some cases, the IP layer 314 may compute an IP header checksum and add the IP header checksum to the packet. The Ethernet layer 316 may then receive the packet.

In some examples, the Ethernet layer 316 may search for a MAC address of the next destination of the packet. In some cases, the Ethernet layer 316 may search for the MAC address by using an Address Resolution Protocol (ARP). In some examples, the Ethernet layer 316 may then add an Ethernet header to the packet.

In some examples, the driver 320 may then request packet transmission to the device portion 318. In some examples, the packet transmission may be requested according to a driver-NIC communication protocol. After receiving the packet transmission request and prior to transmitting the packet, the device portion 318 may add an Inter-Frame Gap (IFG), a preamble, and a cyclic redundancy check (CRC) to the packet.

In some examples, the driver 320 may receive TCP/UDP flow statistics from other portions of the kernel portion 306 (or network stack). For example, the driver 320 may receive the flow statistics over an application programming interface (API). In some cases, the statistics may be associated with the TCP/UDP flow. In some cases, the flow statistics may further include one or more of a number of packets associated with the TCP/UDP flow, a number of bytes associated with the TCP/UDP flow, or QoS level associated with the TCP/UDP flow. In some examples, the flow statistics may assist the driver 320 or the device portion 318 in determining which flows to flow control.

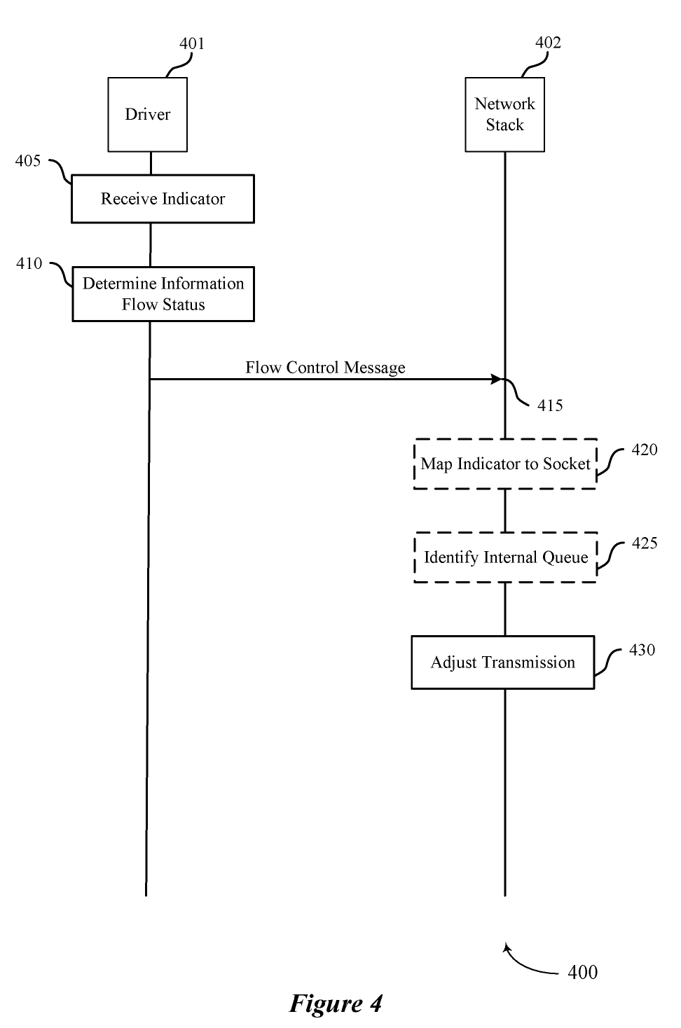

FIG. 4 illustrates an example of a process flow 400 that supports flow controlling a network stack in accordance with various aspects of the present disclosure. In some examples, the process flow 400 may implement aspects of wireless communications system 100. In some examples, a driver 401 and a network stack 402 may be included in a STA 115 or an AP 105. A STA 115 may be an example of, or include the components of, a wireless device such as the wireless device 600, the wireless device 705, or the wireless device 805 described below with reference to FIGS. 6, 7 and 8, respectively. An AP 105 may be an example of, or include the components of, a wireless device such as the wireless device 500, the wireless device 705, or the wireless device 805 described below with reference to FIGS. 5, 7 and 8, respectively.

At 405, the driver 401 may receive an indicator associated with a transmit queue. In some examples in which the driver 401 is included in an AP 105, the transmission may be destined for a second wireless device such as a second AP 105 or a STA 115. Similarly, in some examples in which the driver 401 is included in a STA 115, the transmission may be destined for a second wireless device such as an AP 105 or a second STA 115.

In some examples, the received indicator may include an indication of congestion associated with a QoS level of the transmission. In some examples, the indicator may further include an indication of a destination address associated with the transmission. Additionally or alternatively, the indicator may be associated with a TCP/UDP flow. In some cases, the indicator associated with the TCP/UDP flow may further include one or more of an IP destination address, an IP source address, an IP protocol, a TCP/UDP source port, or a TCP/UDP destination port.

At 410, the driver 401 may determine an information flow status based at least in part on the received indicator. For example, the information flow status may be based on a QoS level specified in the indicator. In some examples, the information flow status may be based on a combination of the QoS level and a destination address. In some other examples, the information flow status may be based on the indicator associated with the TCP/UDP flow. At 415, the driver 401 may generate a flow control message based on the information flow status and transmit the flow control message to the network stack 402.

The network stack 402 may optionally map information associated with the flow control message to a socket at 420. For example, the network stack 402 may map the QoS level to a socket based at least in part on the received indicator associated with the transmission. In some implementations, the network stack 402 may map the combination of the QoS level as well as the destination address to a socket based at least in part on the indicator associated with the transmission. Additionally or alternatively, the network stack 402 may map the TCP/UDP flow to a socket based at least in part on the received flow control message. In some implementations, the network stack 402 may map the TCP/UDP flow to a socket based at least in part on an indicator included within the received flow control message.

In some implementations, at 425, the network stack 402 optionally identifies at least one internal queue associated with the received indicator. In some implementations, the network stack 402 may identify at least one internal queue associated with the QoS level. In one example, the network stack 402 may identify at least one internal queue associated with the combination of the QoS level and the destination address. In some other implementations, the network stack 402 may generate at least one internal queue associated with the QoS level, or with a combination of the QoS level and the destination address.

At 430, the network stack 402 may adjust a transmission flow of one or more packets based at least in part on the flow control message. For example, the network stack 402 may refrain from transmitting one or more packets based on the flow control message.

FIG. 5 illustrates a block diagram of an AP 500 that supports flow controlling a network stack in accordance with various aspects of the present disclosure. For example, the AP 500 may be an example of aspects of the AP 105 described with reference to FIG. 1. The AP 500 can be configured to send and receive WLAN frames (also referred to herein as transmissions or communications) conforming to an IEEE 802.11 standard (such as the 802.11ac or 802.11ax amendments to the 802.11 family of standards), as well as to encode and decode such frames. The AP 500 includes a processor 510, a memory 520, at least one transceiver 530 and at least one antenna 540. In some implementations, the AP 500 also includes a network communications module 570. Each of the components (or “modules”) described with reference to FIG. 6 can communicate with one another, directly or indirectly, over at least one bus 505.

The memory 520 can include random access memory (RAM) and read-only memory (ROM). The memory 520 also can store processor or computer-executable software (SW) code 525 containing instructions that, when executed by the processor 510, cause the processor to perform various functions described herein for wireless communication, including generation and transmission of a downlink frame and reception of an uplink frame. SW code 525 may further include code to implement aspects of the present disclosure, including code to support flow controlling a network stack. SW code 525 may be stored in a non-transitory computer-readable medium such as system memory or other memory.

The processor 510 can include an intelligent hardware device for example, a central processing unit (CPU), a microcontroller, an application-specific integrated circuit (ASIC), or a programmable logic device (PLD) such as a field programmable gate array (FPGA), among other possibilities. The processor 510 may be configured to execute computer-readable instructions stored in a memory to perform various functions (such as functions or tasks supporting flow controlling a network stack). The processor 510 processes information received through the transceiver 530 and the network communications module 570. The processor 510 also can process information to be sent to the transceiver 530 for transmission through the antenna 540, information to be sent to the network communications module 570. The processor 510 can generally be configured to perform various operations related to generating and transmitting a downlink frame and receiving an uplink frame.

The transceiver 530 can include a modem to modulate packets and provide the modulated packets to the antenna 540 for transmission, as well as to demodulate packets received from the antenna 540. The transceiver 530 can be implemented as at least one radio frequency (RF) transmitter and at least one separate RF receiver. The transceiver 530 can communicate bi-directionally, via the antenna 540, with at least one STA 115 as, for example, shown in FIG. 1. Although only one transceiver 530 and one antenna 540 are shown in FIG. 6, the AP 500 can typically include multiple transceivers 530 and antennas 540. For example, in some AP implementations, the AP 500 can include multiple transmit antennas (each with a corresponding transmit chain) and multiple receive antennas (each with a corresponding receive chain). The AP 500 may communicate with a core network 580 through the network communications module 570. The system also may communicate with other APs, such as APs 105, using the core network 580.

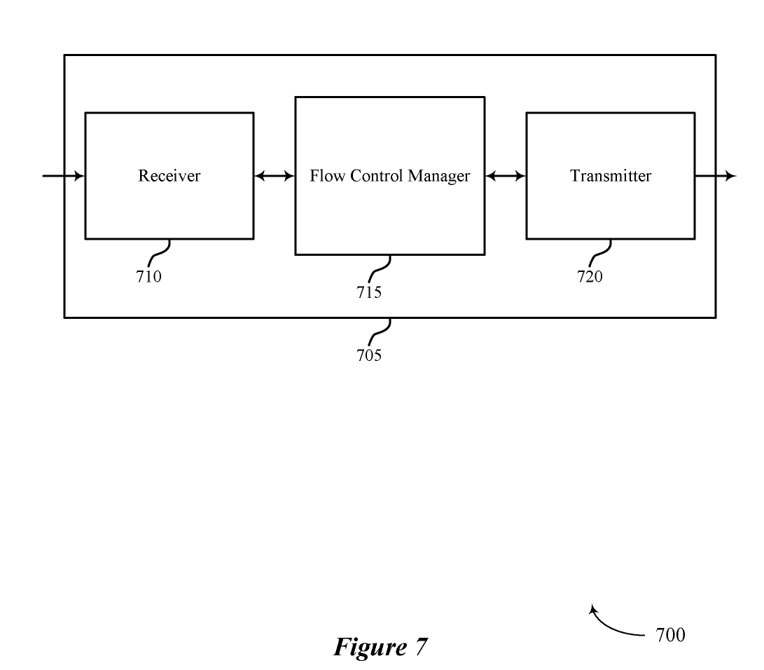

FIG. 6 illustrates a block diagram of a STA 600 that supports flow controlling a network stack in accordance with various aspects of the present disclosure. For example, the STA 600 may be an example of aspects of the STA 115 described with reference to FIG. 1. The STA 600 can be configured to send and receive WLAN frames (also referred to herein as transmissions or communications) conforming to an IEEE 802.11 standard (such as the 802.11ac or 802.11ax amendments to the 802.11 family of standards), as well as to encode and decode such frames. The STA 600 includes a processor 610, a memory 620, at least one transceiver 630 and at least one antenna 640. In some implementations, the STA 600 additionally includes one or more of sensors 650, a display 660 and a user interface (UI) 670 (such as a touchscreen or keypad). Each of the components (or “modules”) described with reference to FIG. 7 can communicate with one another, directly or indirectly, over at least one bus 605.

The memory 620 can include RAM and ROM. The memory 620 also can store processor- or computer-executable SW code 625 containing instructions that, when executed, cause the processor 610 to perform various functions described herein for wireless communication, including reception of a downlink frame and generation and transmission of an uplink frame. SW code 625 may further include code to implement aspects of the present disclosure, including code to support flow controlling a network stack. SW code 625 may be stored in a non-transitory computer-readable medium such as system memory or other memory.

The processor 610 includes an intelligent hardware device such as a CPU, a microcontroller, an ASIC or a PLD such as an FPGA, among other possibilities. The processor 610 may be configured to execute computer-readable instructions stored in a memory to perform various functions (such as functions or tasks supporting flow controlling a network stack). The processor 610 processes information received through the transceiver 630 as well as information to be sent to the transceiver 630 for transmission through the antenna 640. The processor 610 can be configured to perform various operations related to receiving a downlink frame and generating and transmitting an uplink frame.

The transceiver 630 can include a modem to modulate packets and provide the modulated packets to the antenna 640 for transmission, as well as to demodulate packets received from the antenna 640. The transceiver 630 can be implemented as at least one RF transmitter and at least one separate RF receiver. The transceiver 630 can communicate bi-directionally, via the antenna 640, with at least one AP 105 as, for example, shown in FIG. 1. Although only one transceiver 630 and one antenna 640 are shown in FIG. 7, the STA 600 can include two or more antennas. For example, in some STA implementations, the STA 600 can include multiple transmit antennas (each with a corresponding transmit chain) and multiple receive antennas (each with a corresponding receive chain).

FIG. 7 shows a block diagram 700 of a wireless device 705 that supports flow controlling a network stack in accordance with various aspects of the present disclosure. The wireless device 705 may be an example of aspects of a STA 115 or an AP 105 as described herein. The wireless device 705 may include a receiver 710, a flow control manager 715 and a transmitter 720. The wireless device 705 may also include a processor. Each of these components may be in communication with one another (for example, via one or more buses).

The receiver 710 may receive information such as packets, user data, or control information associated with various information channels (such as control channels, data channels, and information related to flow controlling a network stack, etc.). Information may be passed on to other components of the wireless device. The receiver 710 may be an example of aspects of the transceiver 530 described with reference to FIG. 5 or the transceiver 630 described with reference to FIG. 6. The receiver 710 may utilize a single antenna or a set of antennas.

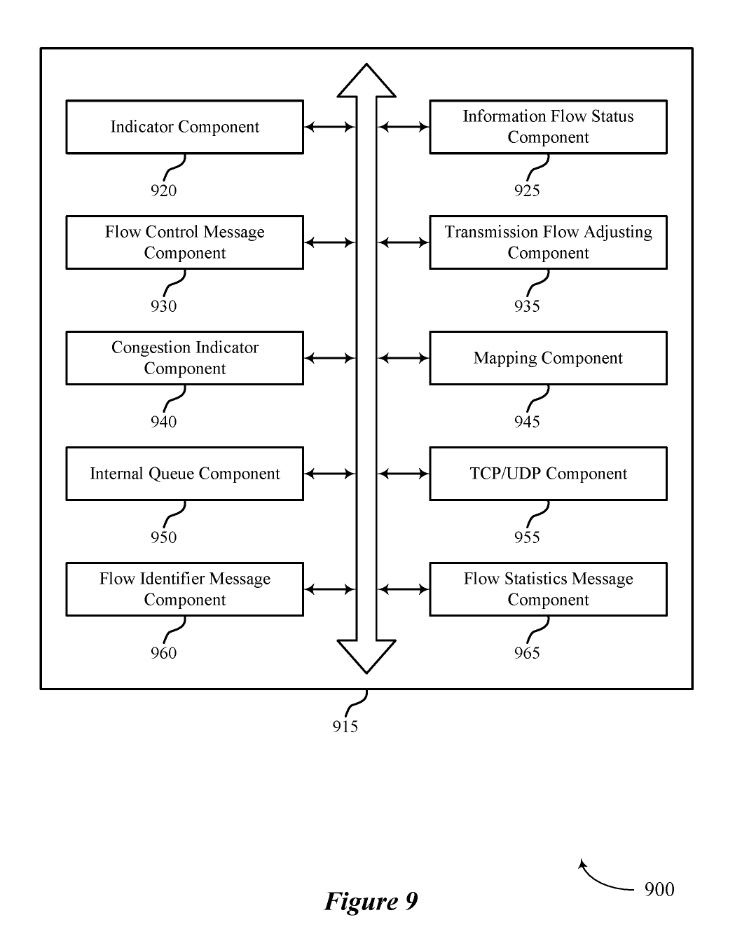

The flow control manager 715 may be an example of aspects of the flow control manager 915 described below with reference to FIG. 9. The flow control manager 715 or at least some of its various sub-components may be implemented in hardware, software executed by a processor, firmware, or any combination thereof. If implemented in software executed by a processor, the functions of the flow control manager 715, or at least some of its various sub-components, may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure. The flow control manager 715 or at least some of its various sub-components may be physically located at various different locations, including being distributed such that portions of functions are implemented at different physical locations by one or more physical devices. In some examples, the flow control manager 715 or at least some of its various sub-components may be a separate and distinct component in accordance with various aspects of the present disclosure. In other examples, the flow control manager 715 or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The flow control manager 715 may receive, at a driver of the wireless device 705, an indicator associated with a transmission. The flow control manager 715 determines an information flow status associated with the wireless device 705 based on the received indicator, and sends, to a network stack of the wireless device 705, a flow control message based on the information flow status. The flow control manager 715 may also adjust a transmission flow of one or more packets associated with the wireless device 705 based on the flow control message.

The transmitter 720 may transmit signals generated by other components of the wireless device 705. In some examples, the transmitter 720 may be collocated with the receiver 710 in a transceiver module. For example, the transmitter 720 may be an example of aspects of the transceiver 530 described with reference to FIG. 5 and transceiver 630 described with reference to FIG. 6. The transmitter 720 may utilize a single antenna or a set of antennas.

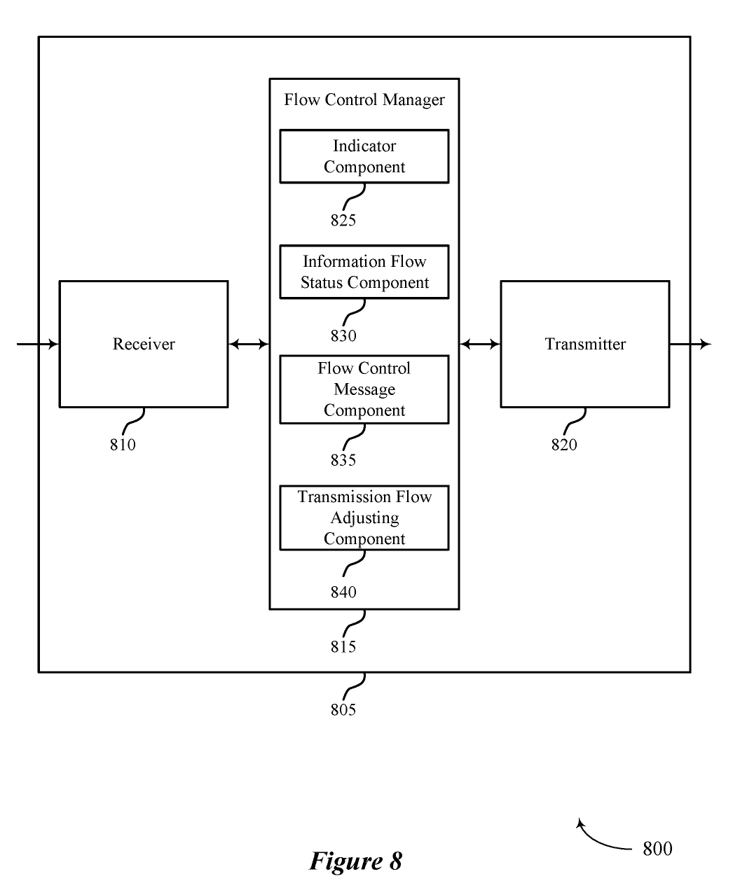

FIG. 8 shows a block diagram 800 of a wireless device 805 that supports flow controlling a network stack in accordance with various aspects of the present disclosure. The wireless device 805 may be an example of aspects of a wireless device such as a STA 115, an AP 105, or the wireless device 705 as described with reference to FIG. 7. Wireless device 805 may include a receiver 810, a flow control manager 815 and a transmitter 820. The wireless device 805 may also include a processor. Each of these components may be in communication with one another (such as via one or more buses).

The receiver 810 may receive information such as packets, user data, or control information associated with various information channels (such as control channels, data channels, and information related to flow controlling the network stack, etc.). Information may be passed on to other components of the wireless device 805. The receiver 810 may be an example of aspects of the transceiver 530 described with reference to FIG. 5 or the transceiver 630 described with reference to FIG. 6. The receiver 810 may utilize a single antenna or a set of antennas.

The flow control manager 815 may be an example of aspects of the flow control manager 815 described with reference to FIG. 8. In some implementations, the flow control manager 815 includes an indicator component 825, an information flow status component 830, a flow control message component 835, and a transmission flow adjusting component 840. The indicator component 825 may receive, at a driver of the wireless device 805, an indicator associated with a transmit queue. In some implementations, indicator component 825 may receive an indicator associated with a future transmission.

The information flow status component 830 may determine an information flow status associated with the wireless device 805 based on the received indicator. The flow control message component 835 may send, to a network stack of the wireless device 805, a flow control message based on the information flow status. The transmission flow adjusting component 840 may adjust a transmission flow of one or more packets to be transmitted from the wireless device 805 based on the flow control message.

The transmitter 820 may transmit signals generated by other components of the wireless device 805. In some examples, the transmitter 820 may be collocated with a receiver 810 in a transceiver module. For example, the transmitter 820 may be an example of aspects of the transceiver 530 described with reference to FIG. 5 or the transceiver 630 described with reference to FIG. 6. The transmitter 820 may utilize a single antenna or a set of antennas.

FIG. 9 shows a block diagram 900 of a flow control manager 915 that supports flow controlling a network stack in accordance with various aspects of the present disclosure. The flow control manager 915 may be an example of aspects of the flow control manager 715, or the flow control manager 815 described with reference to FIGS. 7 and 8, respectively. In some implementations, the flow control manager 915 may include an indicator component 920, an information flow status component 925, a flow control message component 930, a transmission flow adjusting component 935, a congestion indicator component 940, a mapping component 945, an internal queue component 950, a TCP/UDP component 955, a flow identifier message component 960, and a flow statistics message component 965. Each of these modules may communicate, directly or indirectly, with one another (such as via one or more buses).

The indicator component 920 may receive an indicator associated with a transmission. In some implementations, the indicator component 920 may include a driver of a wireless device. The information flow status component 925 may determine an information flow status associated with the wireless device based on the received indicator. The flow control message component 930 may send, to a network stack of the wireless device, a flow control message based on the information flow status. The transmission flow adjusting component 935 may adjust a transmission flow of one or more packets to be transmitted from the wireless device based on the flow control message.

The congestion indicator component 940 may determine an indication of congestion. In some implementations, the indication of congestion is associated with a QoS level of the transmission. In some cases, the indicator further includes an indication of a destination address associated with the transmission. In some implementations, the congestion indicator component 940 may send the determined indicator to the indicator component 920.

The mapping component 945 may map the QoS level to a socket based on the indicator associated with the transmission. In some implementations, the transmission flow adjusting component 935 may use the mapping to adjust the transmission flow of one or more packets by refraining (or causing the wireless device to refrain) from transmitting one or more packets from the socket mapped to the QoS level. In some implementations, the mapping component 945 maps both the QoS level and the destination address to a socket based on the indicator associated with the transmission. In some such implementations, the transmission flow adjusting component 935 may use the mapping to adjust the transmission flow of one or more packets by refraining (or causing the wireless device to refrain) from transmitting one or more packets from the socket mapped to the QoS level and the destination address. In some other implementations, the mapping component 945 may map the TCP/UDP flow to a socket based on the indicator associated with the transmission. In such implementations, the transmission flow adjusting component 935 may use the mapping to adjust the transmission flow of one or more packets by refraining (or causing the wireless device to refrain) from transmitting one or more packets from the socket mapped to the TCP/UDP flow.

The internal queue component 950 identify at least one existing internal queue associated with the QoS level. In some other instances, the internal queue component 950 may instead generate at least one internal queue associated with the QoS level. In some implementations, the transmission flow adjusting component 935 adjusts the transmission flow of one or more packets by refraining (or causing the wireless device to refrain) from transmitting one or more packets associated with the at least one internal queue associated with the QoS level.

In some other implementations or instances, the internal queue component 950 may identify or generate at least one internal queue associated with both the QoS level and the destination address. In some such implementations, the transmission flow adjusting component 935 adjusts the transmission flow of one or more packets by refraining (or causing the wireless device to refrain) from transmitting one or more packets associated with the at least one internal queue associated with both the QoS level and the destination address.

The TCP/UDP component 955 may determine a TCP or UDP flow from the received indicator. In some implementations, the indicator further includes one or more of an IP destination address, an IP source address, an IP protocol, a TCP/UDP source port, or a TCP/UDP destination port. The flow identifier message component 960 may send, using an API of the network stack, a flow identifier message identifying the TCP/UDP flow.

The flow statistics message component 965 may send, using an API of the network stack, a flow statistics message identifying one or more statistics associated with the TCP/UDP flow. In some implementations or instances, the one or more statistics associated with the TCP/UDP flow further include one or more of a number of packets associated with the TCP/UDP flow, a number of bytes associated with the TCP/UDP flow, or QoS level associated with the TCP/UDP flow.

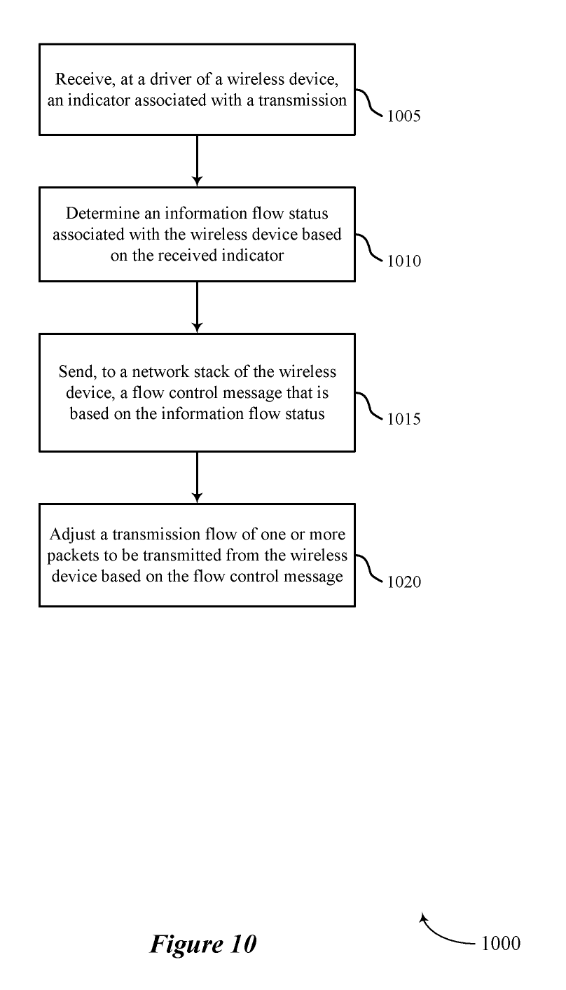

FIG. 10 shows a flowchart illustrating a method 1000 for flow controlling a network stack in accordance with various aspects of the present disclosure. The operations of the method 1000 may be implemented by a wireless device such as the STA 115 or the AP 105 described herein. For example, the operations of the method 1000 may be performed by a flow control manager as described with reference to FIGS. 7 through 9. In some examples, the wireless device executes a set of codes to control the functional elements of the respective wireless device to perform the functions described below. Additionally or alternatively, the wireless device may perform aspects of the functions described below using special-purpose hardware.

At block 1005 the wireless device receives, at a driver of the wireless device, an indicator associated with a transmission. In some implementations, the indicator is associated with a future transmission. In some implementations, aspects of the operations of block 1005 may be performed by an indicator component as described with reference to FIGS. 7 through 9.

At block 1010 the wireless device determines an information flow status associated with the wireless device based at least in part on the received indicator. In some implementations, aspects of the operations of block 1010 may be performed by an information flow status component as described with reference to FIGS. 7 through 9.

At block 1015 the wireless device sends, to a network stack of the wireless device, a flow control message that is based at least in part on the information flow status. In some implementations, aspects of the operations of block 1015 may be performed by a flow control message component as described with reference to FIGS. 7 through 9.

At block 1020 the wireless device adjusts a transmission flow of one or more packets to be transmitted from the wireless device based at least in part on the flow control message. In some implementations, aspects of the operations of block 1020 may be performed by a transmission flow adjusting component as described with reference to FIGS. 7 through 9.

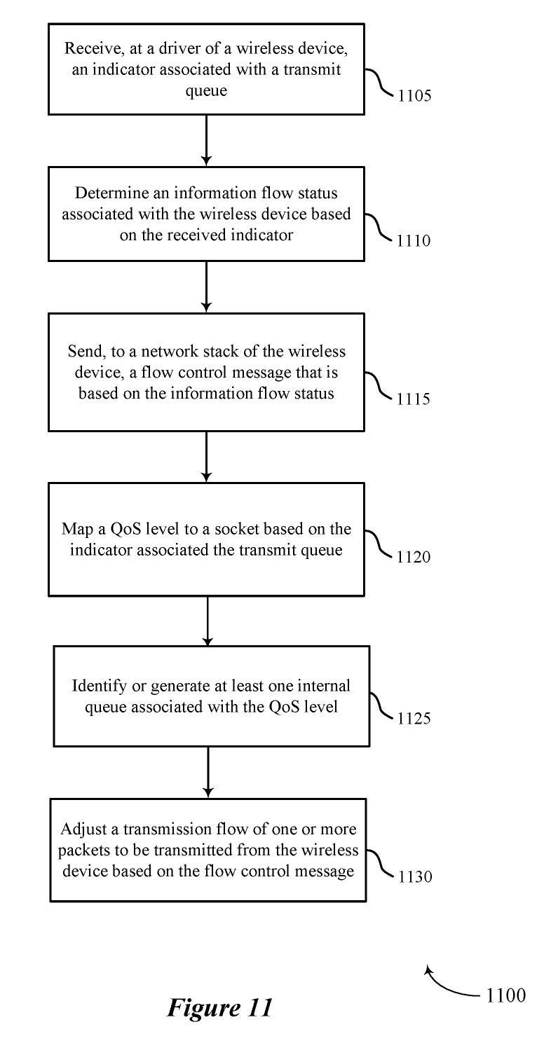

FIG. 11 shows a flowchart illustrating a method 1100 for flow controlling a network stack in accordance with various aspects of the present disclosure. The operations of method 1100 may be implemented by a wireless device such as the STA 115 or the AP 105 described herein. For example, the operations of method 1100 may be performed by a flow control manager as described with reference to FIGS. 7 through 9. In some examples, the wireless device executes a set of codes to control the functional elements of the device to perform the functions described below. Additionally or alternatively, the wireless device may perform aspects of the functions described below using special-purpose hardware.

At block 1105 the wireless device receives, at a driver of the wireless device, an indicator associated with a transmit queue. In some implementations or instances, the indicator may include an indication of a congestion state of the transmit queue. In some implementations, aspects of the operations of block 1105 may be performed by an indicator component as described with reference to FIGS. 7 through 9.

At block 1110 the wireless device determines an information flow status associated with the wireless device based at least in part on the received indicator. In some implementations or instances, the indicator includes an indication of congestion associated with a particular QoS level of the transmit queue. In some instances, the indicator further includes a destination address associated with the transmit queue. In some implementations, aspects of the operations of block 1110 may be performed by an information flow status component as described with reference to FIGS. 7 through 9.

At block 1115 the wireless device sends, to a network stack of the wireless device, a flow control message that is based at least in part on the information flow status. In certain examples, aspects of the operations of block 1115 may be performed by a flow control message component as described with reference to FIGS. 7 through 9.

At block 1120 the wireless device maps the QoS level to a socket based at least in part on the indicator associated with the transmit queue. In some other implementations or instances in which the received indicator further includes a destination address, the wireless device maps the combination of both the QoS level and the destination address to the socket. In some implementations, aspects of the operations of block 1120 may be performed by a mapping component as described with reference to FIGS. 7 through 9.

At block 1125 the wireless device identifies or generates at least one internal queue associated with the QoS level. In some implementation, aspects of the operations of block 1125 may be performed by an internal queue component as described with reference to FIGS. 7 through 9.

At block 1130 the wireless device adjusts a transmission flow of one or more packets to be transmitted from the wireless device based at least in part on the flow control message. In some implementations, adjusting the transmission flow of one or more packets includes refraining from transmitting one or more packets from the socket, such as the socket mapped in block 1120. Additionally or alternatively, in some implementations or instances, adjusting the transmission flow of one or more packets includes refraining from transmitting one or more packets from the internal queue. In some implementations, aspects of the operations of block 1130 may be performed by a transmission flow adjusting component as described with reference to FIGS. 7 through 9.

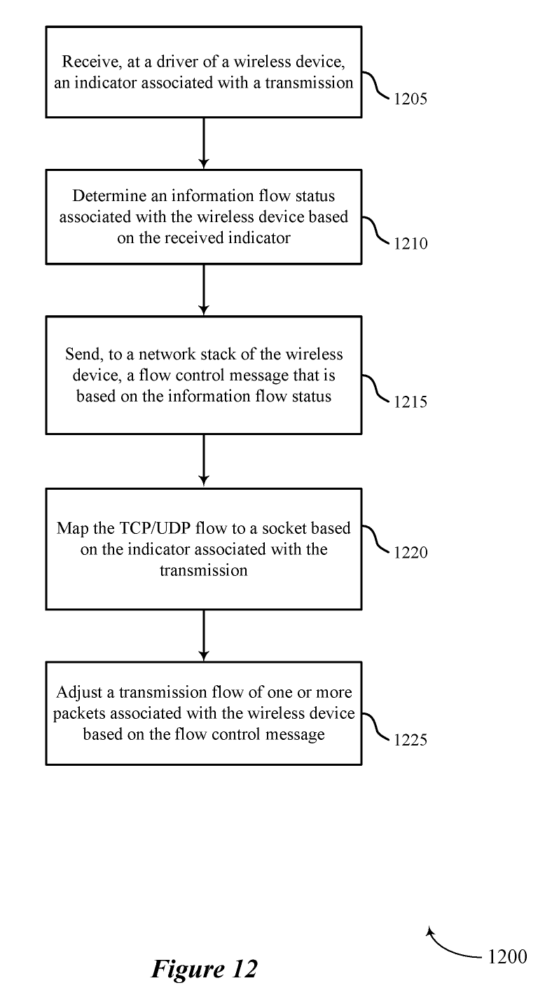

FIG. 12 shows a flowchart illustrating a method 1200 for flow controlling a network stack in accordance with various aspects of the present disclosure. The operations of method 1200 may be implemented by a wireless device such as the STA 115 or the AP 105 described herein. For example, the operations of method 1200 may be performed by a flow control manager as described with reference to FIGS. 7 through 9. In some examples, the wireless device executes a set of codes to control the functional elements of the wireless device to perform the functions described below. Additionally or alternatively, the wireless device may perform aspects of the functions described below using special-purpose hardware.

At block 1205 the wireless device receives, at a driver of the wireless device, an indicator associated with a transmission. In some cases, the indicator is associated with a TCP/UDP flow. In some implementations, aspects of the operations of block 1205 may be performed by an indicator component as described with reference to FIGS. 7 through 9.

At block 1210 the wireless device determines an information flow status associated with the wireless device based at least in part on the received indicator. In some implementations, aspects of the operations of block 1210 may be performed by an information flow status component as described with reference to FIGS. 7 through 9.

At block 1215 the wireless device sends, to a network stack of the wireless device, a flow control message that is based at least in part on the information flow status. In some implementations, aspects of the operations of block 1215 may be performed by a flow control message component as described with reference to FIGS. 7 through 9.

At block 1220 the wireless device maps the TCP/UDP flow to a socket based at least in part on the indicator associated with the transmission. In some implementations, aspects of the operations of block 1220 may be performed by a mapping component as described with reference to FIGS. 7 through 9.

At block 1225 the wireless device adjusts a transmission flow of one or more packets associated with the wireless device based at least in part on the flow control message. In some implementations, adjusting the transmission flow of one or more packets includes refraining from transmitting one or more packets from the socket mapped in block 1220. In some implementations, aspects of the operations of block 1225 may be performed by a transmission flow adjusting component 935 as described with reference to FIGS. 7 through 9.

It should be noted that the methods described above describe possible implementations, and that the operations and the operations may be rearranged or otherwise modified and that other implementations are possible. Furthermore, aspects from two or more of the methods may be combined.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a DSP, an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes, operations and methods may be performed by circuitry that is specific to a given function.

As described herein, in some aspects implementations of the subject matter described in this specification can be implemented as software. For example, various functions of components disclosed herein or various blocks or aspects of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. The claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable sub-combination. As such, although features may be described above as acting in particular combinations, and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless communication at a wireless device, comprising:
receiving, at a driver of the wireless device, an indicator associated with a transmission;
determining an information flow status associated with the wireless device based at least in part on the received indicator;
sending, to a network stack of the wireless device, a flow control message, the flow control message being based at least in part on the information flow status; and
adjusting a transmission flow of one or more packets associated with the wireless device based at least in part on the flow control message.

2. The method of claim 1, wherein the indicator comprises an indication of congestion associated with a Quality of Service (QoS) level of the transmission.

3. The method of claim 2, further comprising mapping the QoS level to a socket based at least in part on the indicator associated with the transmission, wherein adjusting the transmission flow of one or more packets comprises refraining from transmitting one or more packets from the socket.

4. The method of claim 2, further comprising identifying at least one internal queue associated with the QoS level, wherein adjusting the transmission flow of one or more packets comprises refraining from transmitting one or more packets associated with the at least one internal queue.

5. The method of claim 2, further comprising creating at least one internal queue associated with the QoS level, wherein adjusting the transmission flow of one or more packets comprises refraining from transmitting one or more packets associated with the at least one internal queue.

6. The method of claim 2, wherein the indicator further comprises an indication of a destination address associated with the transmission.

7. The method of claim 6, further comprising mapping the QoS level and the destination address to a socket based at least in part on the indicator associated with the transmission, wherein adjusting the transmission flow of one or more packets comprises refraining from transmitting one or more packets from the socket.

8. The method of claim 6, further comprising identifying at least one internal queue associated with the QoS level and the destination address, wherein adjusting the transmission flow of one or more packets comprises refraining from transmitting one or more packets associated with the at least one internal queue.

9. The method of claim 6, further comprising creating at least one internal queue associated with the QoS level and the destination address, wherein adjusting the transmission flow of one or more packets comprises refraining from transmitting one or more packets associated with the at least one internal queue.

10. The method of claim 1, wherein the indicator is associated with a Transmission Control Protocol/User Datagram Protocol (TCP/UDP) flow.

11. The method of claim 10, wherein the indicator further comprises one or more of an Internet Protocol (IP) destination address, an IP source address, an IP protocol, a TCP/UDP source port, or a TCP/UDP destination port.

12. The method of claim 10, further comprising mapping the TCP/UDP flow to a socket based at least in part on the indicator associated with the transmission, wherein adjusting the transmission flow of one or more packets comprises refraining from transmitting one or more packets from the socket.

13. The method of claim 10, further comprising sending, using an application program interface (API) of the network stack, a flow identifier message identifying the TCP/UDP flow.

14. The method of claim 10, further comprising sending, using an application program interface (API) of the network stack, a flow statistics message identifying one or more statistics associated with the TCP/UDP flow.

15. The method of claim 14, wherein the one or more statistics associated with the TCP/UDP flow further comprise one or more of a number of packets associated with the TCP/UDP flow, a number of bytes associated with the TCP/UDP flow, Quality of Service (QoS) level associated with the TCP/UDP flow.

16. An apparatus for wireless communication, comprising:
means for receiving, at a driver of the apparatus, an indicator associated with a transmission;
means for determining an information flow status associated with the apparatus based at least in part on the received indicator;
means for sending, to a network stack of the apparatus, a flow control message, the flow control message being based at least in part on the information flow status; and
means for adjusting a transmission flow of one or more packets associated with the apparatus based at least in part on the flow control message.

17. The apparatus of claim 16, wherein the indicator comprises an indication of congestion associated with a Quality of Service (QoS) level of the transmission.

18. The apparatus of claim 17, further comprising:
means for mapping the QoS level to a socket based at least in part on the indicator associated with the transmission.

19. An apparatus for wireless communication, comprising:
a processor;
memory in electronic communication with the processor; and
instructions stored in the memory and operable, when executed by the processor, to cause the apparatus to:
receive, at a driver of the apparatus, an indicator associated with a transmission;
determine an information flow status associated with the apparatus based at least in part on the received indicator;
send, to a network stack of the apparatus, a flow control message, the flow control message being based at least in part on the information flow status; and
adjust a transmission flow of one or more packets associated with the apparatus based at least in part on the flow control message.

20. The apparatus of claim 19, wherein the indicator comprises an indication of congestion associated with a Quality of Service (QoS) level of the transmission.

21. The apparatus of claim 20, wherein the instructions are further executable by the processor to:
map the QoS level to a socket based at least in part on the indicator associated with the transmission.

22. The apparatus of claim 20, wherein the instructions are further executable by the processor to:
identify at least one internal queue associated with the QoS level.

23. The apparatus of claim 20, wherein the instructions are further executable by the processor to:
create at least one internal queue associated with the QoS level.

24. The apparatus of claim 20, wherein the indicator further comprises an indication of a destination address associated with the transmission.

25. The apparatus of claim 24, wherein the instructions are further executable by the processor to:
map the QoS level and the destination address to a socket based at least in part on the indicator associated with the transmission.

26. The apparatus of claim 24, wherein the instructions are further executable by the processor to:
identify at least one internal queue associated with the QoS level and the destination address.

27. The apparatus of claim 24, wherein the instructions are further executable by the processor to:
create at least one internal queue associated with the QoS level and the destination address.

28. The apparatus of claim 19, wherein the indicator is associated with a Transmission Control Protocol/User Datagram Protocol (TCP/UDP) flow.

29. A non-transitory computer readable medium storing code for wireless communication at a wireless device, the code comprising instructions executable by a processor to:
receive, at a driver of the wireless device, an indicator associated with a transmission;
determine an information flow status associated with the wireless device based at least in part on the received indicator;
send, to a network stack of the wireless device, a flow control message, the flow control message being based at least in part on the information flow status; and
adjust a transmission flow of one or more packets associated with the wireless device based at least in part on the flow control message.

30. The non-transitory computer-readable medium of claim 29, wherein the indicator comprises an indication of congestion associated with a Quality of Service (QoS) level of the transmission.
